(19) United States
(12) Patent Application Publication
(10) Pub. No.: US 2026/0007120 A1
(43) Pub. Date: Jan. 8, 2026

(54) PET CLOTHING HAVING IMPROVED NIGHT VISIBILITY

(71) Applicant: Jong Ho PARK, Seoul (KR)

(72) Inventor: Jong Ho PARK, Seoul (KR)

(21) Appl. No.: 19/224,165

(22) Filed: May 30, 2025

(30) Foreign Application Priority Data
Jul. 2, 2024 (KR) 10-2024-0086527

(51) Int. Cl. A01K 13/00; A01K 11/00

(52) U.S. Cl. CPC A01K 13/006; A01K 11/008

(57) ABSTRACT

Disclosed is a pet clothing having improved night visibility, which includes a first fabric having a shape for surrounding a torso of a pet and provided with openings into which a head and legs are accepted, a second fabric having a binding tool coupled to the first fabric and divided into storage sections, an LED display provided in a first storage section of the second fabric to function to display visual information through an LED array, a microcontroller provided in a second storage section of the second fabric and electrically connected to the LED display to control an operation including at least one of an on/off control of the LED display and an input/output control for the visual information displayed on the LED display, and a battery provided in a third storage section of the second fabric to supply power to the microcontroller.

### CROSS-REFERENCE TO RELATED PATENT APPLICATIONS

The present application claims the right of priority to and the benefits of Korean Application No. 10-2024-0086527having a filing date of Jul. 2, 2024, the content of which is hereby incorporated by reference in its entirety.

### BACKGROUND OF THE INVENTION

### 1. Field of the Invention

The present invention relates to a pet clothing having improved night visibility, and more particularly, to the technology of using an LED array to implement identification information including a pet name, owner contact information and pet registration number as visual information on a pet clothing worn by a pet during going out, thereby providing highly visible identification information about the pet regardless of day or night.

### 2. Description of the Related Art

Due to the improvement of economic standards, aging and declining birth rates, and changes in population structure, the number of people raising pets is increasing worldwide, and the number of people considering pets as members of the family is also increasing.

As pet owners do not spare the cost of raising the pets and the demand for various products and services related to pets is increasing, the pet-related industry is growing rapidly, and the scope of the industry is expanding.

The global pet-related market size is expected to reach $378.1 billion in 2022, grow at an average annual rate of 7.5% after 2022 and reach $780.4 billion in 2032. The domestic pet-related market size is expected to reach KRW 2,920 billion in 2021 and expand to KRW 4,120 billion in 2028.

These pet-related industries are indicated as having high market shares in the pet food market and pet supplies market when viewed in terms of the overall market share. Pet identification tags are mandatory for pets to wear when going out, based on the Animal Protection Act, and may be one of the pet supplies that people can easily come across around the people.

However, most pet identification tags are printed with text, it is difficult to easily recognize identification information included in tags having small fonts, and visibility may be further reduced at night.

Accordingly, Korean unexamined utility model No. 20-2009-0009077 discloses the technology in which a gap expansion structure is adopted to form a focal gap in order to enlarge and provide pet identification information expressed in small fonts by using a convex lens. However, the above-described related art may enlarge small text to a certain extent but cannot solve the problem of poor night visibility, so there is a limitation that the effect of improving visibility is insignificant.

### SUMMARY OF THE INVENTION

Thus, an object of the present invention is to provide a technology of using an LED array to implement identification information including a pet name, owner contact information and pet registration number as visual information on a pet clothing worn by a pet during going out,

In addition, another object of the present invention is to provide a technology of providing identification information about a pet by using an LED array, in which heat generated from the LED array is easily dissipated while insulating a section adjacent to a body of the pet, so as to provide the pet with a positive clothing wearing experience, and prevent a failure and a shortened lifespan of an LED display due to overheating.

In addition, a still another object of the present invention is to provide a technology of providing a pet clothing having an increased search efficiency upon an accident that a pet wearing the clothing based on the present invention goes missing or the clothing based on the present invention is lost.

In order to achieve the above objects, a pet clothing implemented by a computing device including one or more processors and one or more memories for storing instructions executable in the processors according to the present invention and having improved night visibility includes: a first fabric having a shape for surrounding a torso of a pet and provided therein with openings into which a head and legs of the pet are accepted; and a second fabric having a binding tool coupled to the first fabric, and divided into a plurality of storage sections; and further includes: an LED display provided in a first storage section of the second fabric to function to display visual information through an LED array formed by arranging a plurality of LEDs on a flexible substrate having flexibility; a microcontroller (MCU) provided in a second storage section of the second fabric and electrically connected to the LED display to control an operation including at least one of an on/off control of the LED display and an input/output control for the visual information displayed on the LED display; and a battery provided in a third storage section of the second fabric to supply power to the microcontroller, and further includes: a speaker provided in a fourth storage section of the second fabric and having an operation related to an output of an acoustic signal and controlled by the microcontroller, wherein the LED display is stored in the first storage section while being stored in a dedicated housing for storing the LED array, and the dedicated housing is composed of a front part, a rear part opposite the front part, and at least two side parts for connecting the front part with the rear part, in which the front part includes an open section finished with a transparent material to allow visual information displayed by the LED display to be identified from an outside, the rear part is formed of a non-conductive material to prevent heat generated from the LED array from being transferred toward a body of the pet, and the side parts are formed of a conductive material and provided therein with a plurality of heat dissipation fins protruding outward to function to release the heat generated from the LED array, and wherein the microcontroller is installed with a wireless transceiver for supporting Bluetooth communication to pair and connect the wireless transceiver with a user terminal located within a preset critical distance, thereby allowing two-way communication, so as to provide the paired user terminal with an input interface for visual information displayed on the LED display through a dedicated application, and includes a GPS module for functioning to receive GPS signals and provide location information to provide location information including real-time location information and previous location information confirmed by the GPS module to the user terminal through the wireless transceiver when a device search request is received from the paired user terminal, and the microcontroller controls the speaker to output a sound signal having a preset frequency band when the device search request is received from the user terminal through the wireless transceiver, the microcontroller further includes a noise sensor capable of measuring decibels, upon reception of the device search request, to transmit a sound signal in an audible range through the speaker when an ambient noise value measured by the noise sensor is equal to or higher than a preset decibel level, and transmit a sound signal in an audible range through the speaker when the ambient noise value measured by the noise sensor is below the preset decibel level.

According to one embodiment of the present invention, the LED array is used to implement identification information including a pet name, owner contact information and pet registration number as visual information on a pet clothing worn by a pet during going out, so that highly visible identification information about the pet can be provided regardless of day or night.

In addition, according to one embodiment of the present invention, the LED display for displaying pet identification information including a pet name, owner contact information and a pet registration number as visual information can be easily edited, so that two or more pets can use one device economically, and an identification tool for pets capable of immediately reflecting changes in identification information can be provided even when changes occur in the identification information.

In addition, according to one embodiment of the present invention, when identification information about a pet is provided by using an LED array, heat generated from the LED array can be easily dissipated while insulating a section adjacent to a body of the pet, so that the pet can be provided with a positive clothing wearing experience, and a failure and a shortened lifespan of the LED display due to overheating can be prevented.

In addition, according to one embodiment of the present invention, location information useful for the search can be provided or visual and auditory navigation device can be provided upon an accident that a pet wearing the clothing based on the present invention goes missing or the clothing based on the present invention is lost, so that the search efficiency can be improved.

### BRIEF DESCRIPTION OF THE DRAWINGS

FIG. 1 is a conceptual diagram showing the configuration of a pet clothing having improved night visibility according to one embodiment of the present invention.

FIG. 2 is an example showing a schematic implementation form of a second fabric according to one embodiment of the present invention.

FIGS. 3 and 4 are examples showing a binding tool for binding a first fabric and a second fabric to each other according to one embodiment of the present invention.

FIGS. 5 to 6B are configuration diagrams showing an LED display according to one embodiment of the present invention.

FIG. 7 is an example of providing an input interface for controlling the LED display to a user terminal according to one embodiment of the present invention.

FIG. 8 is an example of providing device search results according to one embodiment of the present invention.

FIGS. 9A and 9B are conceptual diagrams of providing precise location information using AoA and AoD technologies of Bluetooth according to one embodiment of the present invention. FIG. 10 is an example of the internal configuration of a computing device according to one embodiment of the present invention.

### DETAILED DESCRIPTION OF THE INVENTION

Hereinafter, various embodiments and/or aspects will be described with reference to the drawings. In the following description, a plurality of specific details are set forth to provide comprehensive understanding of one or more aspects for the purpose of explanation. However, it will also be appreciated by those having ordinary skill in the art that such aspect(s) may be carried out without the specific details. The following description and accompanying drawings will be set forth in detail for specific exemplary aspects among one or more aspects. However, these aspects are illustrative and some of various methods in the principles of the various aspects may be utilized, and the descriptions are intended to include all such aspects and their equivalents.

The terms “embodiment”, “example”, “aspect” and the like used in the present specification may not be construed in that an aspect or design set forth herein is preferable or advantageous than other aspects or designs.

In addition, it will be understood that the terms “include” and/or “including” imply the presence of the corresponding features and/or components, but do not preclude the presence or addition of one or more other features, components and/or groups thereof.

In addition, the terms including an ordinal number such as first and second may be used to describe various components, however, these components are not limited by the above-mentioned terms. The terms are used only for the purpose of distinguishing one component from another component. For example, the first component may be named the second component, and similarly, the second component may also be named the first component, without departing from the scope of the present invention. The term “and/or” includes any one of a plurality of related listed items or a combination thereof.

In addition, In the e embodiments of the present invention, unless otherwise defined, all terms used herein including technical or scientific terms have the same meaning as commonly understood by those having ordinary skill in the art. Terms defined in commonly used dictionaries will be interpreted as having a meaning consistent with their meaning in the context of the relevant technology, and will not be interpreted in an idealized or overly formal sense unless explicitly defined in the embodiments of the present invention.

The present invention relates to a pet clothing having improved night visibility, and more particularly, the first object is to provide technology of using an LED array to implement identification information including a pet name, owner contact information and pet registration number as visual information on a pet clothing worn by a pet during going out, thereby providing highly visible identification information about the pet regardless of day or night.

In addition, according to the present invention, the second object is to provide technology of providing identification information about a pet by using an LED array, in which heat generated from the LED array is easily dissipated while insulating a section adjacent to a body of the pet, so as to provide the pet with a positive clothing wearing experience, and prevent a failure and a shortened lifespan of an LED display due to overheating. The third object of the present invention is to provide a pet clothing having an increased search efficiency upon an accident that a pet wearing the clothing based on the present invention goes missing or the clothing based on the present invention is lost.

Hereinafter, the present invention for achieving the above objects will be described in more detail with reference to the attaching drawings, and a plurality of drawings may be referenced simultaneously to describe one or more technical features or components constituting the invention.

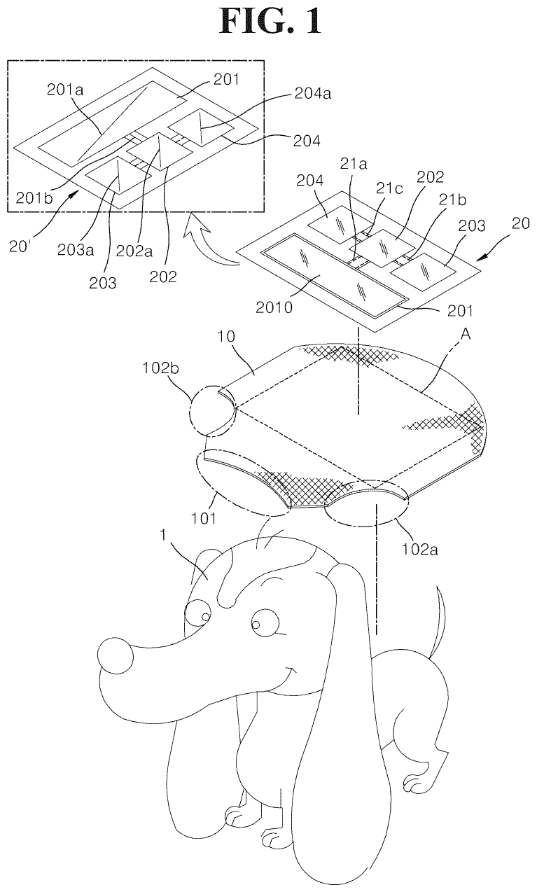

The present invention will be presented in more detail with simultaneous reference to FIG. 1 showing the configuration diagram of the present invention. The present invention includes a first fabric 10 having a shape for surrounding a torso 1 of a pet and provided therein with openings 101, 102a and 102b into which a head and legs of the pet are accepted; and a second fabric 20 provided with a binding tool with respect to the first fabric 10 so as to be coupled to the first fabric 10, and divided into a plurality of storage sections at least including a first storage section 201 for storing an LED display 30, a second storage section 202 for storing a microcontroller 40 described later, a third storage section 203 for storing a battery 50, and a fourth storage section 204 for storing a speaker 60.

In other words, the above-described first fabric 10 may be understood as a concept of fabric directly worn by the pet, and the above-described second fabric 20 may be understood as a concept of fabric attached or coupled to the first fabric 10.

In particular, the second fabric 20 is used as a section for storing a plurality of modular components as described later, and accordingly, at least one cutting line 201a, 202a, 203a and 204a may be formed on a rear surface 20′ of the second fabric 20 for each storage section to easily store or remove the modular components. Further, a plurality of cables for connection to the microcontroller 40 described later may be included, and accordingly, cable storage sections 21a, 21b and 21c for connecting each storage section 201, 203 and 204 may be formed around the second storage section 202 installed therein with the microcontroller 40.

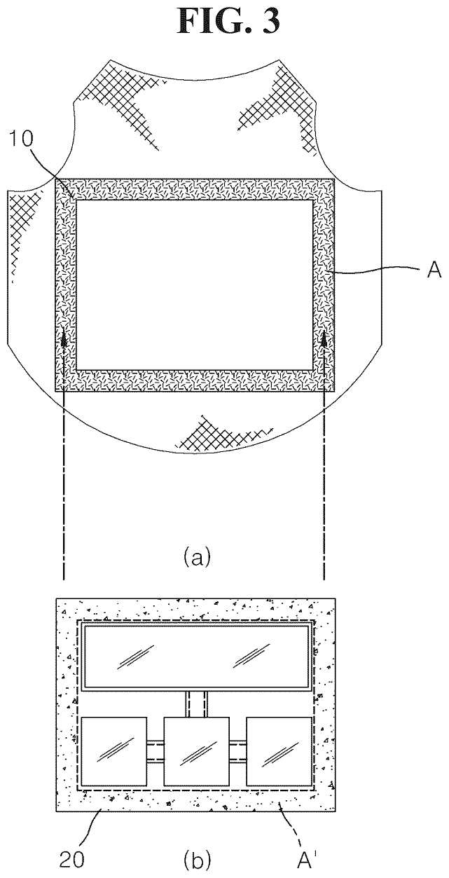

In addition, the binding between the first fabric 10 and the second fabric 20 may be accomplished by various binding tools. Referring to parts (a) and (b) of FIG. 3 as an example, the upper part (a) of FIG. 3 shows an example in which a hook surface A formed thereon with fine hooks is formed on one section of the first fabric 10 (a front surface of the first fabric 10), and the lower part (b) of FIG. 3 shows an example in which a loop surface A′ formed of velvet is formed on one corresponding section of the second fabric 20 (the rear surface of the second fabric 20). According to the present invention, an easily attached and detached binding tool may be selected and used by coupling the first fabric 10 and the second fabric 20 to each other via hook-and-loop fastening between the hook surface A and the loop surface A′, and applying an external force to separate the second fabric 20 bound to the first fabric 10 when desired.

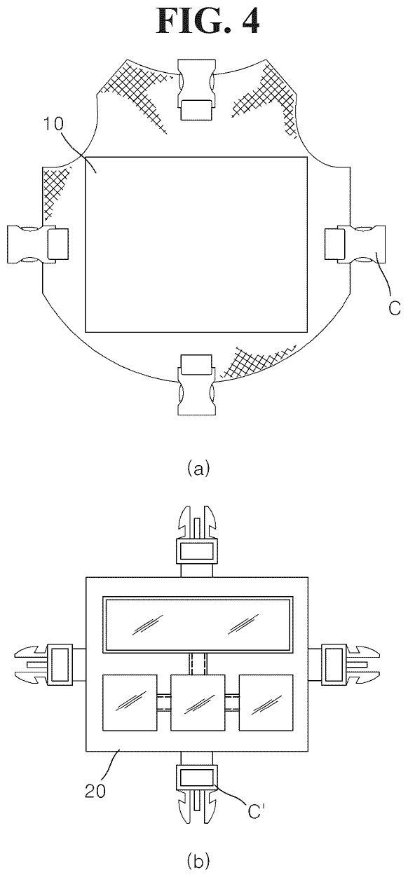

In addition, referring to FIG. 4 as another embodiment, at least one female buckle C may be provided in the first fabric 10 and at least one male buckle C′ may be provided in the corresponding section of the second fabric 20, so that the first fabric 10 may be fastened to the second fabric 20 in a binding (locking) manner between the female buckle C and the male buckle C′. When the above binding manner is used, a strong bond between the first fabric 10 and the second fabric 20 may be provided and the two fabrics may be separated from each other without a large force upon separation.

Meanwhile, the second fabric 20 is provided with a plurality of storage sections as described above. The storage sections may have the same size and shape, but all of the size and shape may be different, or some storage sections may have the same size and shape and the other storage sections may have different sizes and shapes. The present invention is not limited thereto.

Meanwhile, an LED display 30 for displaying visual information through an LED array formed by arranging a plurality of LEDs on a flexible substrate having flexibility may be installed in the first storage section 201 among the storage sections provided in the second fabric 20.

As one embodiment, a polyimide substrate may be used for the flexible substrate, and it will be understood that the flexible substrate is used as a substrate for implementing the LED display 30 in the present invention because the LED display 30 is allowed to be bent in a shape corresponding to a body curve of a pet due to the nature of a pet clothing for surrounding the pet body, thereby providing an improved wearing feeling when the pet wears the clothing based on the present invention.

Meanwhile, the LED display 30 may display information including a pet name, owner contact information and a pet registration number as visual information by controlling an on/off status of the LED array. The above configuration of the LED display 30 can resolve the problem that the conventional pet identification tag for indicating information about a pet through simple printing fails to easily obtain identification information about the pet due to the significantly lowered visibility at night having reduced light amounts, and accordingly, can function as an identification tag having high visibility regardless of day or night.

In addition, the LED display 30 mentioned in the present invention may further include a heat dissipation tool configured to resolve the heat generation problem that occurs when the LED array displays the visual information.

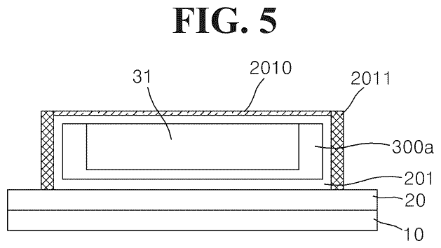

As one embodiment, in more detail with reference to FIG. 5, the heat dissipation tool may further include a heat dissipation frame formed of a conductive material that surrounds the edge of the LED array constituting the LED display 30.

The conductive material may be, for example, one of aluminum, copper and silver, or may be an alloy material containing at least one thereof, and functions to absorb heat generated from the LED array to lower the heat of the LED array by utilizing the heat transfer principles of conduction and convection.

Although not shown in FIG. 5, in another preferred embodiment of the present invention, the heat dissipation frame for surrounding the LED array may have an outer shape formed in a wave shape or provided with a plurality of protrusions to increase the surface area of the heat dissipation frame, thereby further increasing the heat dissipation effect. The present invention is not limited thereto.

In addition, it is preferable that the first storage section 201 provided in the second fabric 20 of the present invention may have an upper surface finished with a transparent material 2010, so that the visual information output from the LED display 30 stored therein is easily identified from the outside, and the section forming a bonding surface with the first fabric 10 may be formed of an insulating material, so that heat of the heat dissipation frame having an increased temperature due to the heat absorbed by the LED array is prevented from being transferred to the pet.

As one embodiment, the insulating material may be formed of, for example, mineral wool, glass fiber, and cellulose fiber, or the second fabric 20 forming the bonding surface with the first fabric 10 may be finished with an insulating material such as polystyrene, expanded polystyrene, or polyethylene to provide insulation properties.

In addition, as another preferred embodiment of the present invention, the side section other than the bonding surface in the second fabric 20 with respect to the first fabric 10 may be formed of a breathable material.

For example, a mesh-shape material may be applied to the material of the side section to facilitate the inflow of outside air, and this may be understood as a configuration for cooling the heat dissipation frame that has the increased temperature after absorbing the heat from the LED array.

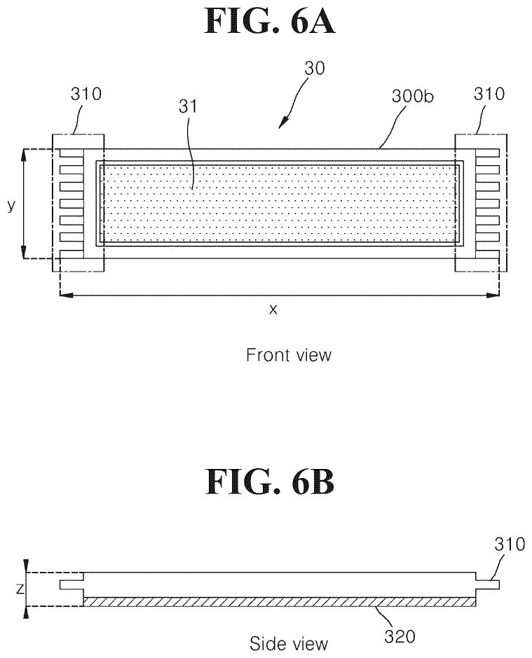

Meanwhile, referring simultaneously to FIGS. 6A and 6B as another embodiment of the heat dissipation tool, in the present invention, the LED display 30 may further include a dedicated housing for storing the LED array, so that the dedicated housing is stored in the first storage section 201 of the second fabric 20.

The dedicated housing is composed of a front part, a rear part opposite the front part, and at least two side parts for connecting the front part with the rear part, in which the front part includes an open section finished with a transparent material, so that the visual information displayed by the LED display 30 may be identified from the outside.

In addition, the rear part may be formed of a non-conductive material (such as polystyrene, expanded polystyrene or polyethylene) to prevent the heat generated at the LED array from being transferred to the pet's body. The side parts may be formed of a conductive material to absorb the heat generated at the LED array, and may be provided with a plurality of heat dissipation fins 310 protruding outward to expand a radiation surface, thereby further maximizing the effect of dissipating (radiating) the heat generated from the LED array.

Meanwhile, the microcontroller 40, which is electrically connected to the LED display 30 to perform an operational control including at least one of an on/off control of the LED display 30 and an input/output control for the visual information displayed on the LED display 30, is stored in the second storage section 202 of the second fabric 20.

The microcontroller 40 may be installed with a wireless transceiver for supporting Bluetooth communication to pair and connect the wireless transceiver with a user terminal located within a preset critical distance (maximum 10 meters), thereby supporting two-way communication, and may provide the paired user terminal with an input interface for the visual information displayed on the LED display 30 through a dedicated application.

Specifically, the visual information displayed on the LED display 30 may be edited through an input interface in the user terminal paired with the wireless transceiver based on Bluetooth communication.

As one embodiment, the input interface may provide an input field for identification information including at least one of a pet name, owner contact information and a pet registration number as visual information for the LED display 30. When the identification information is collected through an input device of the user terminal, the collected identification information may be displayed as visual information on the LED display 30.

In addition, in the more preferred embodiment of the present invention, the LED display 30 of the present invention may include, as sections for displaying the visual information, a first LED display section configured to receive the input for the identification information including the pet name, the owner contact information and the pet registration number to implements the received input as the visual information, and a second LED display section for implementing user-customized decoration information as the visual information.

According to the present invention, because it is important to expose the identification information to the outside, the first LED display section may be preferably allocated to be relatively wider than the second LED display section in the LED array constituting the LED display 30.

Meanwhile, the user terminal paired with the clothing of the present invention is provided with, as input interfaces provided through the dedicated application, a first input interface for receiving the input of the identification information implemented in the first LED display section from the user terminal, and a second input interface for simulating the configuration of the LED array of the second display section to receive the input for the user-defined decoration information implemented in the second LED display section.

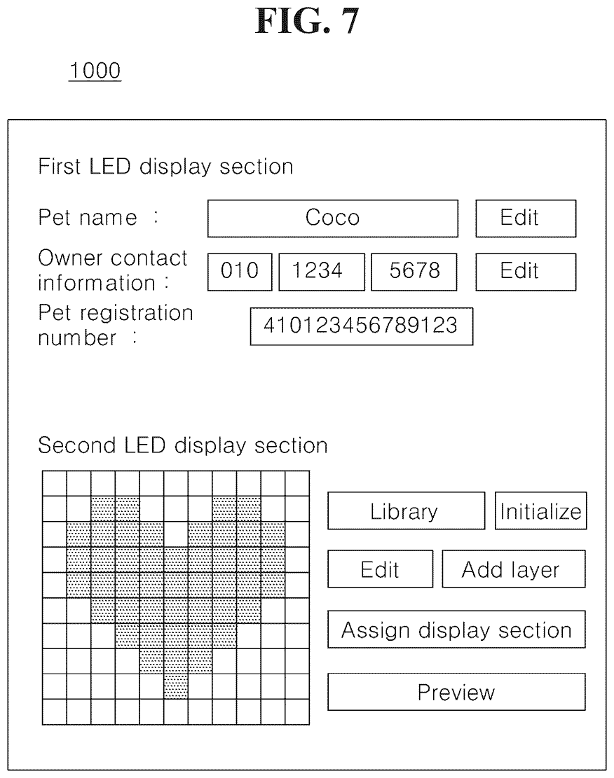

As one embodiment, 1000 of FIG. 7 shows an example of the input interface provided to the user terminal.

In addition, it can be seen that 1000 of FIG. 7 shows, as the input interface for the first LED display section, an example of the first input interface including an input and editing menu of the identification information, and an example of the second input interface in which the user-customized decoration information for the LED display section is input.

As described above, it is shown as an example in which the configuration for the second LED display section allocated in the LED display 30 is simulated in the second input interface, and a selection input for the second LED display section is received through the input device of the user terminal, so that the LED-operational control is performed with respect to the second LED display section.

In other words, the LED array, which is the arrangement of LEDs forming the second LED display section, is simulated in the second input interface, so that the second input interface is provided by activating (ON) corresponding LEDs when the user terminal selects and inputs deactivated LEDS, and deactivating (OFF) corresponding LEDs when the user terminal selects and inputs activated LEDs, thereby receiving the user-customized decoration information.

In other embodiments of the present invention, decoration information may be loaded and used from a library, which stores multiple decoration information, without directly selecting and inputting the LEDs constituting the LED array simulated on the user terminal, or user-customized decoration information may be received by editing and inputting the decoration information loaded from the library.

In addition, in another embodiment of the present invention, the user-customized decoration information may be saved plurally in two or more layers, and then the user-customized decoration information input into plurally saved layers may be sequentially or randomly implemented on the LED display 30 at preset unit cycles. The present invention is not limited thereto.

In addition, In still another embodiment of the present invention, the position of the second LED display section may be adjusted without encroaching on the range allocated to the first LED display section.

For example, when it is assuming that the LED display 30 is considered as 100% in total, the first LED display section is allocated to 80% and the second LED display section is allocated to 20%, the position of the second LED display section allocated to 20% may be adjusted in a direction including at least one of the up, down, left and right directions of the first LED display section.

Further, in the present invention, the position may also be adjusted by dividing the section allocated to the second LED display section, such as placing 10% on the left side of the first LED display section and placing the remaining 10% on the right side of the first LED display section. The present invention is not limited thereto.

Meanwhile, the pet clothing of the present invention includes a battery 50 provided in the third storage section 203 of the second fabric 20 to supply power to the microcontroller 40.

A space for accommodating the battery 50 may be formed in the third storage section 203, and an electrode terminal connected to the battery 50 may be formed to provide the power supplied from the battery 50 to the microcontroller 40.

In addition, as another embodiment of the battery 50 in the present invention, the battery 50 is stored in the third storage section 203, in which the battery 50 may include a battery 50 pack formed of a secondary battery, and a charging terminal for the battery 50 pack may be provided to supply an external power to the battery 50 pack using a power cable. The present invention is not limited thereto.

Meanwhile, according to the pet clothing mentioned in the present invention, the microcontroller 40 is equipped with a GPS module for functioning to receive GPS signals and provide location information, so that, when a device search request is received from the user terminal paired with the wireless transceiver, location information including at least one of real-time location information and previous location information of the pet clothing confirmed by the GPS module may be provided to the user terminal through the wireless transceiver.

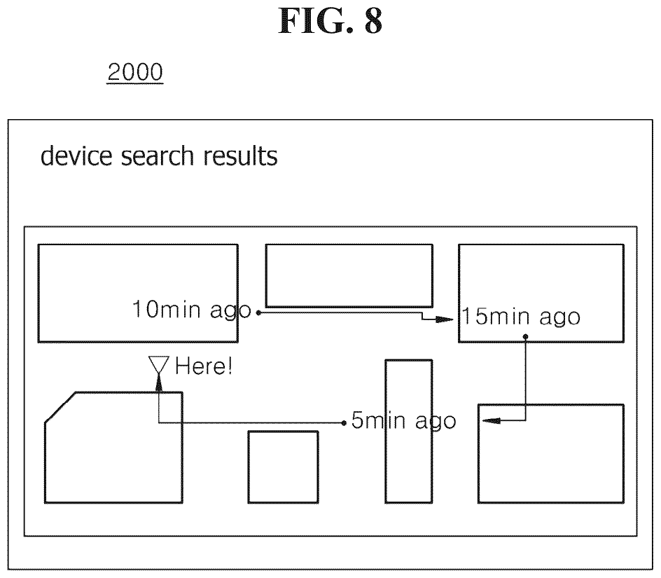

As one embodiment, as shown in 2000 of FIG. 8, for the location information provided to the user terminal, device search results may be provided to the user terminal by mapping location values at the GPS module for a preset unit time interval (e.g., 10 minutes) onto a map.

In other words, since the present invention further includes the GPS module, convenience in finding a pet wearing the pet clothing mentioned in the present invention may be provided by identifying the location of the pet immediately when the pet goes missing, or the location of the device of the present invention may be easily identified when the device of the present invention is lost.

On the other hand, in a more preferred embodiment of the present invention, when a device search request is received by a Bluetooth-based wireless transceiver from the user terminal, location tracking technologies may be used based on an Angle of Arrival (AoA) technology and an Angle of Departure (AoD) technology supported by Bluetooth 5.1, so that precise directional information about a search target device may be additionally provided.

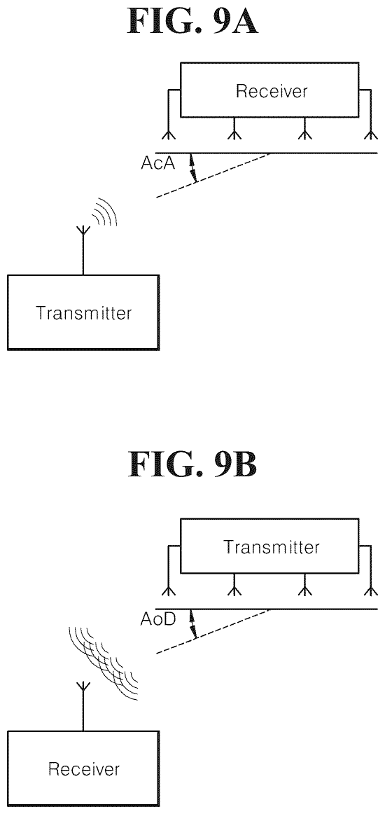

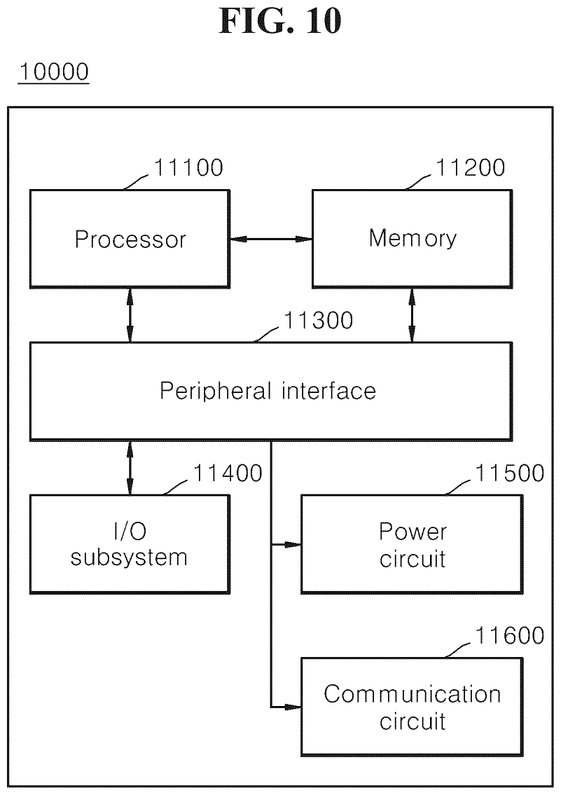

Continuing the description with simultaneous reference to FIGS. 9A and 9B, for the Angle of Arrival technology as shown in the conceptual diagram of FIG. 9A, when the device of the present invention serving as a transmitter transmits a unique direction detection signal by using a single antenna, the relative direction to the device of the present invention may be calculated by using signal phase difference information of the direction detection signal received by a receiver equipped with multiple antennas, and accordingly, more precise direction information than GPS may be provided.

In addition, for the Angle of Departure technology as shown in the conceptual diagram of FIG. 9B, multiple antennas are provided, a plurality of detection signals are transmitted by a transmitter fixed at a specific location, a receiver having a single antenna provided in the device of the present invention receives the detection signals and calculates a phase difference for each antenna, so as to calculate the relative direction of the search target device, and accordingly, more precise direction information than GPS may be provided.

As another preferred embodiment of the present invention, when a device search request is received from the user terminal, the microcontroller 40 may switch the operational control for the LED display 30 to a search mode to increase the search efficiency of the device of the present invention.

Specifically, when the search mode for the device of the present invention is activated, the microcontroller 40 temporarily stops displaying set visual information on the LED display 30, turns on the entire LED array constituting the LED display 30, and then repeats turn-on and turn-off in a preset cycle of blinking pattern.

In other words, according to the present invention, when the search mode is activated, the LED display 30 is controlled to operate in a form having more improved visibility, so that the search efficiency of the device of the present invention may be significantly increased.

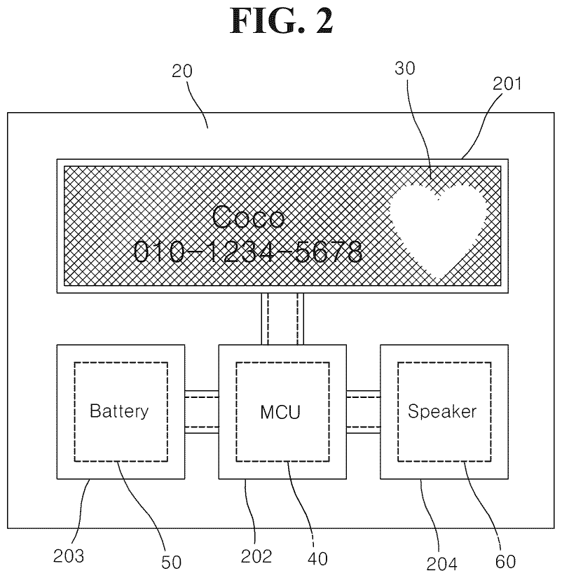

In addition, as schematically shown in FIG. 2 previously described in the present invention, another preferred embodiment of the present invention further include a speaker 60 provided in the fourth storage section 204 of the second fabric 20 and controlled in an operation related to an output of an acoustic signal by the microcontroller 40. When the wireless transceiver receives the device search request from the user terminal, the microcontroller (40) may control the speaker 60 to output a sound signal of a preset frequency band, so that the search efficiency may be increased.

As one embodiment, according to the present invention, the sound signal output from the speaker 60 may be output as an audible sound signal to transmit the sound signal in the audible range from the speaker 60 upon searching for the pet clothing based on the present invention, thereby audibly guiding the location to the user, so that the search efficiency may be increased.

In addition, as one embodiment according to the present invention, in order to prevent noise problems from arising due to the transmission of the sound signals in the audible range, the sound signal may be output within an inaudible range, the sound signal in the inaudible range may be received through a dedicated application executed on the user terminal, and the proximity may be guided based on the size (e.g. decibel size) of the received sound signal in the inaudible range, so that the search efficiency of the device of the present invention may be increased. The present invention is not limited thereto.

In still another embodiment of the present invention, the microcontroller 40 may further include a noise sensor capable of measuring decibels. In the case that a device search is requested, and when the environment is anticipated to be difficult for the user to recognize the sound signal in the audible range from ambient noise values measured by the noise sensor (for example, when the ambient noise is equal to or higher than 60 dB), the sound signal in the inaudible range may be transmitted. When the user is expected to recognize the sound signal in the audible range (e.g., when the ambient noise is less than 60 dB), the sound signal in the audible range may be transmitted, so that the output of sound signals may be selectively controlled according to the level of ambient noise. The present invention is not limited thereto.

Comprehensively, according to the above-described embodiments of the present invention, the LED array is used to implement identification information including a pet name, owner contact information and pet registration number as visual information on a pet clothing worn by a pet during going out, so that highly visible identification information about the pet can be provided regardless of day or night.

In addition, according to one embodiment of the present invention, the LED display for displaying pet identification information including a pet name, owner contact information and a pet registration number as visual information can be easily edited, it can be economical because two or more pets use one device, and an identification tool for pets capable of immediately reflecting changes in identification information can be provided even when changes occur in the identification information.

In addition, according to one embodiment of the present invention, when identification information about a pet is provided by using the LED array, heat generated from the LED array is easily dissipated while insulating a section adjacent to a body of the pet, so that the pet can be provided with a positive clothing wearing experience, and a failure and a shortened lifespan of the LED display due to overheating can be prevented.

In addition, according to one embodiment of the present invention, upon an accident that a pet wearing the clothing based on the present invention goes missing or the clothing based on the present invention is lost, location information useful for the search may be provided or visual and auditory navigation means may be provided, so that the search efficiency can be improved.

Although the embodiments have been described above with limited embodiments and drawings, those skilled in the art will appreciate that various modifications and variations are available based on the above description.

On the other hand, referring to FIG. 10, FIG. 10 shows an example of the internal configuration of a computing device according to one embodiment of the present invention. In the following description, unnecessary descriptions for embodiments redundant with those of FIGS. 1 to 9B will be omitted.

As shown in FIG. 10, the computing device 10000 may include at least one processor 11100, a memory 11200, a peripheral device interface 11300, an input/output subsystem (I/O subsystem) 11400, a power circuit 11500, and a communication circuit 11600. The computing device 10000 may be a user terminal A connected to a tactile interface device or the above-described computing device B.

The memory 11200 may include, for example, a high-speed random access memory, a magnetic disk, an SRAM, a DRAM, a ROM, a flash memory, or a non-volatile memory. The memory 11200 may include software modules, instruction sets, or various other data required for operations of the computing device 10000.

The access to the memory 11200 from other components of the processor 11100 or the peripheral interface 11300, may be controlled by the processor 11100.

The peripheral interface 11300 may combine an input and/or output peripheral device of the computing device 10000 to the processor 11100 and the memory 11200. The processor 11100 may execute the software module or the instruction set stored in memory 11200, thereby performing various functions for the computing device 10000 and processing data.

The I/O subsystem 11400 may combine various I/O peripheral devices to the peripheral interface 11300. For example, the I/O subsystem 11400 may include a controller for combining the peripheral device such as monitor, keyboard, mouse, printer, or a touch screen or sensor, if needed, to the peripheral interface 11300. According to another aspect, the I/O peripheral devices may be combined to the peripheral interface 11300 without passing through the I/O subsystem 11400.

The power circuit 11500 may provide power to all or a portion of the components of the terminal. For example, the power circuit 11500 may include a power failure detection circuit, a power converter or inverter, a power status indicator, a power failure detection circuit, a power converter or inverter, a power status indicator, or arbitrary other components for generating, managing, or distributing power.

The communication circuit 11600 may use at least one external port, thereby enabling communication with other computing devices.

Alternatively, as described above, the communication circuit 11600 may, if necessary, transmit and receive an RF signal, also known as an electromagnetic signal, including RF circuitry, thereby enabling communication with other computing devices.

The embodiment of FIG. 10 is merely an example of the computing device 10000, and the computing device 10000 may have a configuration or arrangement in which some of the components shown in FIG. 10 are omitted, additional components not shown in FIG. 10 are further included, or two or more components are combined. For example, a computing device for a communication terminal in a mobile environment may further include a touch screen or a sensor in addition to the components shown in FIG. 10, and a circuit for RF communication using various communication schemes (such as WiFi, 3G, LTE, Bluetooth, NFC and Zigbee) may be included in the communication circuit (1160). Components that may be included in the computing device 10000 may be implemented by hardware, software, or a combination of both hardware and software which include at least one integrated circuit specialized in a signal processing or an application.

Methods according to embodiments of the present invention may be implemented in the form of program instructions to be executed through various computing devices so as to be recorded in a computer-readable medium. In particular, a program according to the embodiment may be configured as a PC-based program or an application dedicated to a mobile terminal. The application to which the present invention is applied may be installed on a user terminal through a file provided by a file distribution system. For example, the file distribution system may include a file transmission unit (not shown) for transmitting the file according to a request of the user terminal.

The devices described above may be implemented by hardware components, software components, and/or a combination of hardware components and software components. For example, the devices and components described in the embodiments may be implemented by using at least one general purpose computer or special purpose computer, such as a processor, a controller, an arithmetic logic unit (ALU), a digital signal processor, a microcomputer, a field programmable gate array (FPGA), a programmable logic unit (PLU), a microprocessor, or any other device capable of executing and responding to instructions. The processing device may execute an operating system (OS) and at least one software application executed on the operating system.

In addition, the processing device may access, store, manipulate, process, and create data in response to the execution of the software. For ease of understanding, in some cases, one processing device may be used, however, those skilled in the art will appreciate that the processing device may include a plurality of processing elements and/or a plurality of types of processing elements. For example, the processing device may include a plurality of processors or one processor and one controller. In addition, other processing configurations, such as a parallel processor, are also possible.

Software may include a computer program, code, instructions, or a combination of one or more thereof, which may be configured to perform a desired operation on a processing device or may instruct the processing device independently or collectively. The Software and/or data may be permanently or temporarily embodied in any type of machine, component, physical device, virtual equipment, and computer storage medium or device, in order to be interpreted by the processing device or to provide instructions or data to the processing device. The software may be distributed over computing devices connected to networks, so as to be stored or executed in a distributed manner. The software and data may be stored in at least one computer-readable recording medium.

The method according to the embodiment may be implemented in the form of program instructions to be executed through various computing mechanisms so as to be recorded computer-readable medium. The computer-readable medium may include program instructions, data files, data structures, and the like, independently or in combination thereof. The program instructions recorded in the medium may be specially designed and configured for the embodiment, or may be known to those skilled in the art of computer software so as to be used. Examples of the computer-readable recording medium include a magnetic medium such as a hard disk, a floppy disk and a magnetic tape, an optical medium such as a CD-ROM and a DVD, a magneto-optical medium such as a floptical disk, and a hardware device, such as ROM, RAM and flash memory, specially configured to store and execute a program instruction.

Examples of program instructions include a high-level language code to be executed by a computer using an interpreter or the like, as well as a machine code generated by a compiler. The hardware device may be configured to operate as at least one software module to perform the operations of the embodiments, and vice versa.

Although the above embodiments have been described with reference to the limited embodiments and drawings, however, it will be understood by those skilled in the art that various changes and modifications may be made from the above-mentioned description For example, appropriate results may be achieved even though the described techniques may be performed in an order different from the described manner, and/or the described components such as system, structure, device, and circuit may be coupled or combined in a form different from the described manner, or replaced or substituted by other components or equivalents. Therefore, other implementations, other embodiments, and equivalents to the claims are also within the scope of the following claims.

What is claimed is:

1. A pet clothing having improved night visibility and implemented by a computing device including one or more processors and one or more memories for storing instructions executable in the processors, the pet clothing, comprising:
a first fabric having a shape for surrounding a torso of a pet and provided therein with openings into which a head and legs of the pet are accepted;
a second fabric having a binding tool coupled to the first fabric, and divided into a plurality of storage sections;
an LED display provided in a first storage section of the second fabric to function to display visual information through an LED array formed by arranging a plurality of LEDS on a flexible substrate having flexibility;
a microcontroller provided in a second storage section of the second fabric and electrically connected to the LED display to control an operation including at least one of an on/off control of the LED display and an input/output control for the visual information displayed on the LED display;
a battery provided in a third storage section of the second fabric to supply power to the microcontroller; and
a speaker provided in a fourth storage section of the second fabric and having an operation related to an output of an acoustic signal and controlled by the microcontroller,
wherein the LED display is stored in the first storage section while being stored in a dedicated housing for storing the LED array, and the dedicated housing is composed of a front part, a rear part opposite the front part, and at least two side parts for connecting the front part with the rear part, in which the front part includes an open section finished with a transparent material to allow visual information displayed by the LED display to be identified from an outside, the rear part is formed of a non-conductive material to prevent heat generated from the LED array from being transferred toward a body of the pet, and the side parts are formed of a conductive material and provided therein with a plurality of heat dissipation fins protruding outward to function to release the heat generated from the LED array, and
wherein the microcontroller is equipped with a wireless transceiver for supporting Bluetooth communication to pair and connect the wireless transceiver with a user terminal located within a preset critical distance to allow two-way communication, provides the paired user terminal with an input interface for visual information displayed on the LED display through a dedicated application, includes a GPS module configured to receive GPS signals and provide location information to provide the user terminal with location information including real-time location information and previous location information confirmed by the GPS module through the wireless transceiver when a device search request is received from the paired user terminal,
the microcontroller controls the speaker to output a sound signal of a preset frequency band when the device search request from the user terminal is received by the wireless transceiver, and
the microcontroller further includes a noise sensor capable of measuring decibels, upon reception of the device search request, to transmit a sound signal in an inaudible range through the speaker when an ambient noise value measured by the noise sensor is equal to or higher than a preset decibel level, and transmit a sound signal in an audible range through the speaker when the ambient noise value measured by the noise sensor is below the preset decibel level.

2. The pet clothing of claim 1, wherein the LED display includes a heat dissipation frame formed of a conductive material and configured to surround an edge of the LED array,
the first storage section has a section that forms a bonding surface with the first fabric and is formed of an insulating material, and a side section, other than the bonding surface with respect to the first fabric, that is formed of a breathable material.

3. The pet clothing of claim 1, wherein the LED display includes a first LED display section configured to implement an input of identification information including at least one of a pet name, owner contact information and a pet registration number as visual information, and a second LED display section configured to implement user-customized decoration information as visual information, and
the input interface includes a first input interface configured to receive the input of the identification information implemented in the first LED display section from the user terminal, and a second input interface configured to receive an input of the user-customized decoration information implemented in the second LED display section.

4. The pet clothing of claim 1, wherein, when the device search request is received from the user terminal, the wireless transceiver additionally provides precise direction information about a search target device using a technology including at least one of an Angle of Arrival (AoA) technology-based system that provides relative direction information of the search target device by using phase difference information of a direction detection signal transmitted by the search target device reaching a receiver, and an Angle of Departure (AoD) technology-based system that allows the search target device to receive a direction detection signal transmitted from multiple antennas of a transmitter and use phase difference information of the received signal to provide relative direction information of the search target device.
